(19) United States
(12) Patent Application Publication
(10) Pub. No.: US 2026/0114389 A1
(43) Pub. Date: Apr. 30, 2026

(54) SAW BLADE ARRANGEMENT WITH LUBRICANT SUPPLY CHANNEL AND METHODS FOR MANUFACTURING AND USING SUCH A SAW BLADE

(71) Applicant: JPS TEKNIK AB, Ljusdal (SE)

(72) Inventor: Peter SÖRELL, Färila (SE)

(21) Appl. No.: 19/478,025

(22) PCT Filed: Apr. 25, 2024
(86) PCT No.: PCT/SE2024/050399

§ 371 Date: Oct. 23, 2025

(30) Foreign Application Priority Data
Apr. 25, 2023 (SE) 2350491-3

(51) Int. Cl. A01G 23/091; B27B 17/02; B27B 17/12

(52) U.S. Cl. CPC A01G 23/091; B27B 17/025; B27B 17/12

(57) ABSTRACT

Saw blade arrangement (100) for a chainsaw, comprising a chassis (103); a saw blade (110) having a chain guide (116) for a chain (101); a nose part (130) having a chain sprocket (150); and a lubricant provision device (104), arranged to provide a lubricant to the chain (101). The saw blade (110) comprises a lubricant supply channel (121,122) running lengthwise (L) along said chain guide (116) from the chassis (103) to the nose part (130). The saw blade (110) further comprises a lubricant distribution channel (151) arranged to provide lubricant from the lubricant supply channel (121,122) to a chain (101) mounted on the saw blade (110). The lubricant distribution channel (151) is arranged to provide the lubricant to an up-stream lubrication point (154) on the nose part (130) before the chain (101) arrives at the chain sprocket (150). The invention also relates to methods for manufacturing and using such saw blade arrangements.

The present invention relates to a saw blade arrangement for a chainsaw, as well as to a method for manufacturing such a saw blade arrangement and to a method for using such a saw blade arrangement.

Saw blades for chainsaws can conventionally be lubricated. Normally, lubricant oil is supplied at a point where the chain leaves the chassis and runs along a side of the saw blade towards a sprocket arranged at the nose of the saw blade arrangement. The lubrication is required partly at the engagement between the sprocket and the chain needs lubrification, partly at the engagement between the chain and the saw blade. When the chainsaw is used it is typically pressed against a work piece that is to be cut, whereby the moving chain is pressed against the saw blade by the work piece, in the main plane of the saw blade.

It has been found that, under normal usage, a majority of the lubricant does not stay on the chain until put to good use lubricating said engagements. Instead, large shares of the supplied lubricant are thrown off the chain, effectively landing on the ground. This is particularly true in chainsaws for forest harvesters. This way, significant amounts of lubrication oils are spread in nature each year, to environmental detriment and monetary cost.

A forest harvester is a machine with a chainsaw at the end of a robotic arm or similar, the machine being arranged to cut down trees as operated by an operator controlling both the robotic arm and the chainsaw. Typically, such forest harvesters also include gripping means for holding the felled tree and delimbing means to remove branches from the felled tree.

Furthermore, during professional use of a chainsaw, and in particular a chainsaw for a forest harvester, the wear between the chain and the saw blade is such so that the saw blade needs to be turned after a certain usage, instead exposing its other long side edge to the wear before being finally disposed.

Wear is also significant at the nose of the saw blade, and in particular of the nose sprocket. In order to facilitate replacement of the sprocket, the saw blade can have a removable nose part. Such a removable nose part introduces a weakness in the saw blade, making it more prone to breaking.

In case lubricant is provided to a nose part of a chainsaw blade, and in particular in case the blade is a solid-material blade, it has turned out to be difficult to achieve an efficient delivery of such lubricant to select locations at the nose part while still providing adequate strength of the saw blade. This is not least true for constructions having replaceable nose parts.

The present invention solves at least part of the above-described problems.

Hence, the invention relates to a saw blade arrangement for a chainsaw, the saw blade arrangement being associated with a width, a length and a depth, the saw blade arrangement comprising a chassis, comprising a saw blade fastening mechanism arranged to fasten and hold a saw blade; the saw blade, having a chain guide for a chain along each of its side edges facing in opposite width directions; a nose part having a chain sprocket.

In some embodiments, the saw blade arrangement comprises a lubricant provision device, arranged to provide a lubricant to a chain mounted on the saw blade.

In some embodiments, the saw blade comprises a lubricant supply channel running lengthwise along said chain guide from the chassis to the nose part.

In some embodiments, the saw blade comprises a lubricant distribution channel arranged to provide lubricant from the lubricant supply channel to a chain mounted on the saw blade.

In some embodiments, the lubricant distribution channel is arranged to provide the lubricant to an upstream lubrication point on the nose part before the chain arrives at the chain sprocket.

In some embodiments, the chainsaw is a forest harvester.

In some embodiments, the saw blade comprises a blade part in the form of a piece of solid metal material.

In some embodiments, the lubricant supply channel is provided at a bottom of the chain guide.

In some embodiments, the lubricant supply channel is defined by an elongated element being arranged in an open guide channel of the chain guide, the elongated element sealing against inside walls of the open channel and leaving space outside of the elongated element for the chain in and along the open channel.

In some embodiments, the lubricant supply channel is aligned with and connects to the lubricant distribution channel at a lengthwise intersection between the saw blade and the nose part.

In some embodiments, the saw blade comprises one separate lubricant supply channel on either widthwise side of the saw blade, each separate lubricant supply channel running along said chain guide from the chassis to the nose part.

In some embodiments, the lubricant distribution channel comprises two lubricant connecting channel parts, each being aligned with and being connected to a respective one of said separate lubricant supply channels at a lengthwise intersection between the saw blade and the nose part.

In some embodiments, the nose part comprises a first outer plate and a second outer plate.

In some embodiments, the saw blade comprises a central plate, the central plate being arranged depthwise between the first outer plate and the second outer plate when the nose part is mounted on the saw blade.

In some embodiments, the saw blade comprises a first fastening flange and a second fastening flange.

In some embodiments, the first outer plate has a first socket for the first fastening flange and the second outer plate has a second socket for the second fastening flange.

In some embodiments, the first fastening flange and the second fastening flange have shapes that do not align as viewed along the width direction.

In some embodiments, the nose part is fastened to the saw blade using several fasteners. In some embodiments, the fasteners comprise a first fastener fastening together the first fastening flange, the central plate and the second outer plate.

In some embodiments, the fasteners comprise a second fastener fastening together the second fastening flange, the central plate and the first outer plate.

In some embodiments, the lubricant distribution channel has a curvilinear shape, running past said fasteners from the lubricant supply channel to said first upstream lubrication point.

In some embodiments, the first fastening flange and the second fastening flange together cover at least 50% of a width of the nose part near a connection between the nose part and the saw blade.

In some embodiments, the lubricant distribution channel is formed as a recess in the central plate.

In some embodiments, the lubricant distribution channel comprises a first channel part arranged to distribute the lubricant to said upstream lubrication point and also a second channel part arranged to distribute the lubricant to a downstream lubrication point on the nose part after the chain leaves the chain sprocket.

In some embodiments, the lubricant distribution channel comprises at least two first channel parts and at least two second channel parts.

In some embodiments, the first channel part is formed as a recess in the central plate on a first side of the central plate.

In some embodiments, the second channel part is formed as a recess in the central plate on a second, opposite side of the central plate.

In some embodiments, the first channel part is connected to the second channel part via a through hole in the central plate.

Moreover, the invention relates to a method for manufacturing a saw blade arrangement of said type, the method comprising the steps a) providing a saw blade having a chain guide from a chassis of the saw blade arrangement to a nose part of the saw blade; b) sealing off part of the chain guide so as to define a lubricant supply channel running along said chain guide; and c) providing a lubricant distribution channel arranged to provide lubricant from the lubricant supply channel to a chain mounted on the saw blade, the lubricant distribution channel being arranged to provide the lubricant to an upstream lubrication point on the nose part before the chain arrives at the chain sprocket.

In some embodiments, the lubricant supply channel is defined by an elongated element being arranged in an open channel of the chain guide, the elongated element sealing against inside walls of the open channel and leaving space outside of the elongated element for the chain in and along the open channel.

In some embodiments, the elongated element is between 1 and 4 mm in a cross-sectional diameter.

In some embodiments, the elongated element is fastened using press fitting in the open channel, by pressing the elongated element into the open channel to a desired depth.

In some embodiments, the elongated element is fastened to the saw blade using welding or an adhesive at an end of the open channel near the nose part.

In some embodiments, the method further comprises forming the lubricant distribution channel as a recess in a central plate of the saw blade part; and mounting the nose part to the saw blade by fastening a first outer plate and a second outer plate on either side of the central plate.

Furthermore, the invention relates to a method for using a saw blade arrangement of said type, the method comprising the steps a) providing the saw blade arrangement; b) fastening the saw blade arrangement to a chainsaw so that a first long side edge of the saw blade is used as a cutting edge of the saw blade; c) cutting material using the cutting edge while providing lubricant to the chain via the lubricant distribution channel; d) turning the saw blade so that a second long side edge of the saw blade is used as a cutting edge of the saw blade; and e) cutting material using the cutting edge while providing lubricant to the chain via the lubricant distribution channel.

In the following, the invention will be described in detail, with reference to exemplifying embodiments of the invention and to the enclosed drawings, wherein:

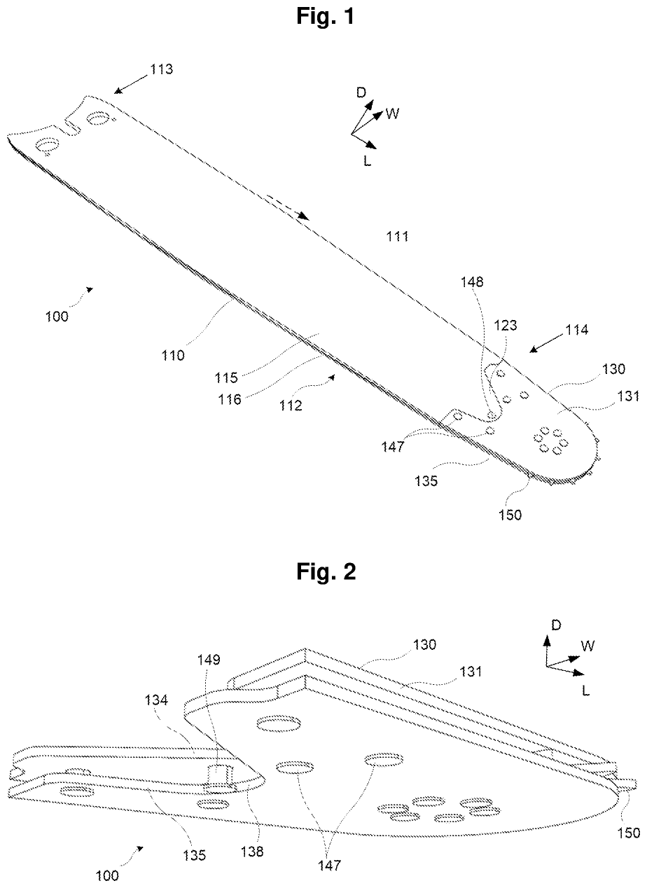

FIG. 1 is perspective view of a first saw blade arrangement 100, comprising a saw blade 110 and a nose part 130;

FIG. 2 is a perspective view of the nose part 130 of the first saw blade arrangement 100;

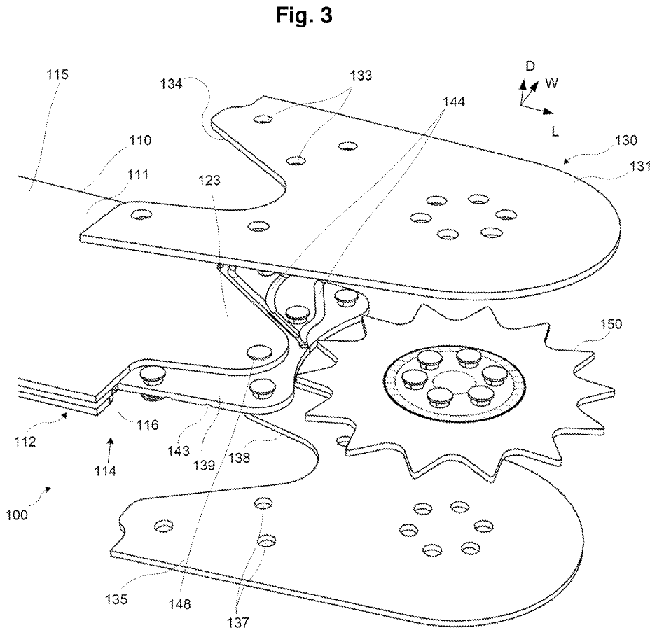

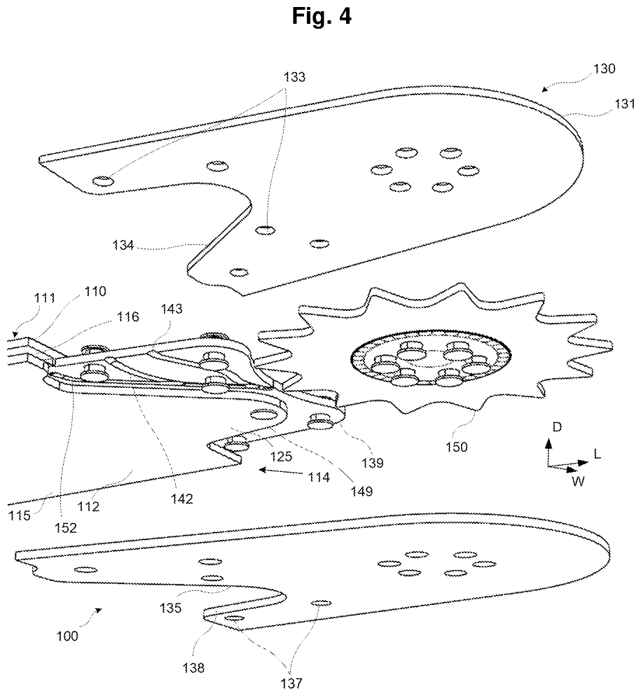

FIGS. 3 and 4 are respective partly exploded detail perspective views, from different angles, of the first saw blade arrangement 100, and in particular showing its nose part 130;

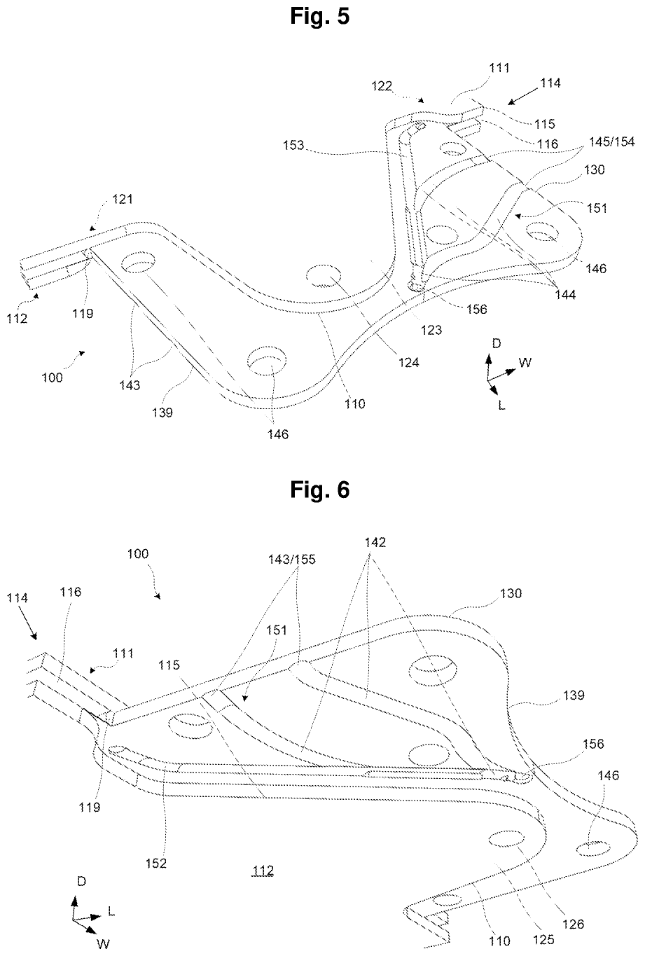

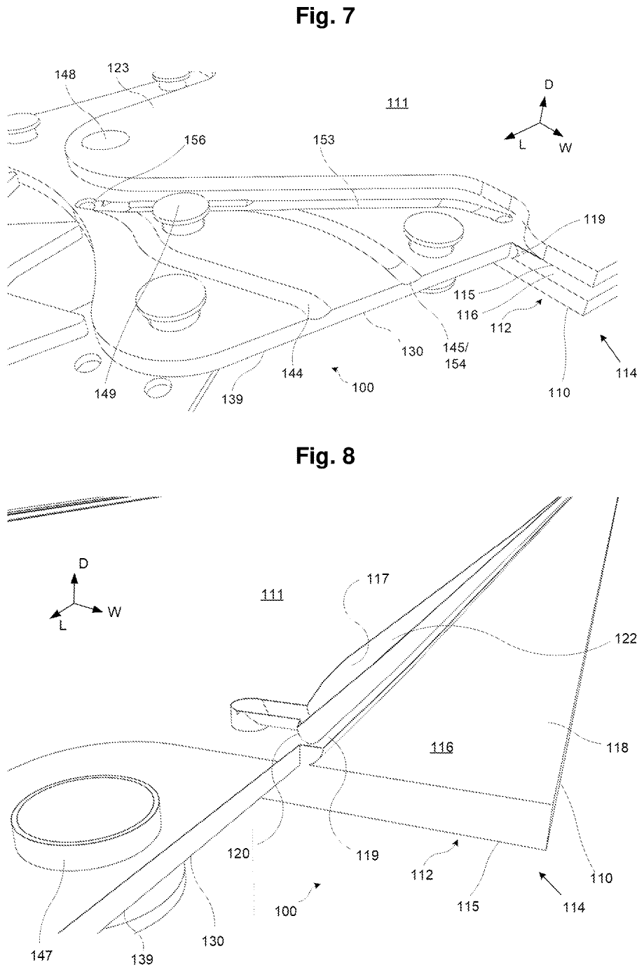

FIGS. 5, 6 and 7 are respective partly removed detail perspective views of the first saw blade arrangement 100, in particular showing a central plate 139 of the saw blade 110;

FIG. 8 is a detail cross-sectional perspective view of the first saw blade arrangement 100, with a length-width cross-section removed;

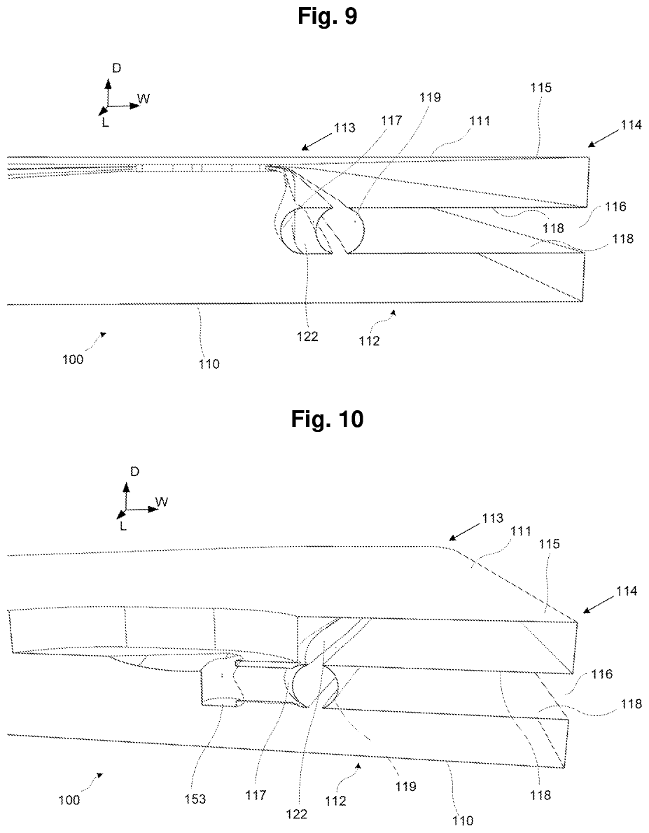

FIGS. 9 and 10 are respective detail cross-sectional perspective views of the first saw blade arrangement 100, with a depth-width cross-section removed;

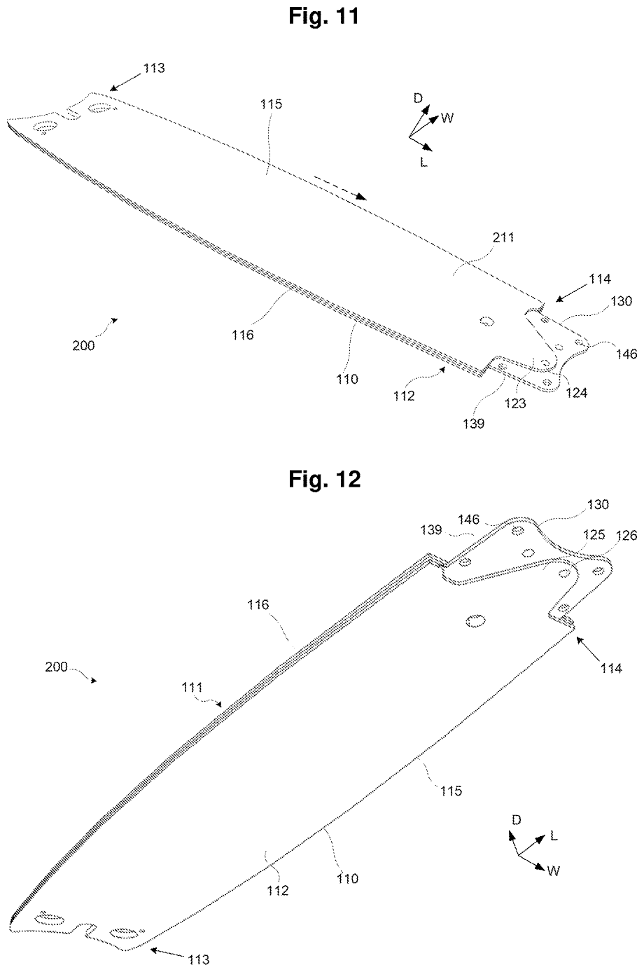

FIGS. 11 and 12 are respective perspective views of a second saw blade arrangement 200, these views being partly removed by a first outer plate 131 and a second outer plate 135 of a nose part 130 of the second saw blade arrangement 200 not being shown;

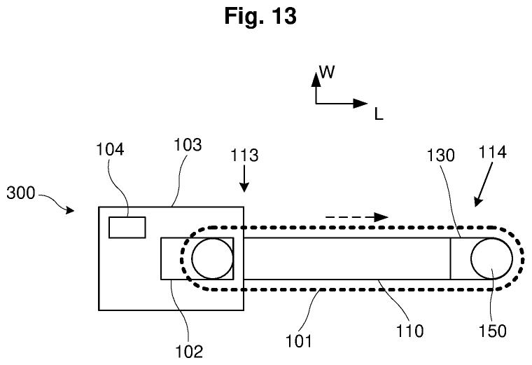

FIG. 13 is a schematic view of a third saw blade arrangement 300;

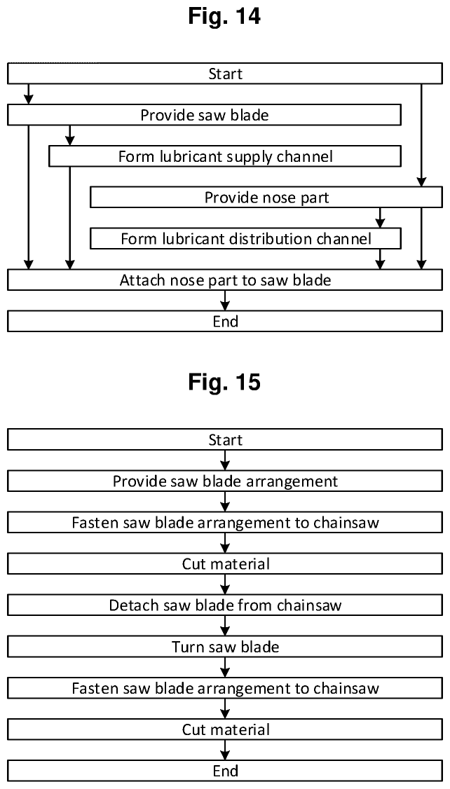

FIG. 14 is a flowchart illustrating a first method; and

FIG. 15 is a flowchart illustrating a second method.

It is noted that all Figures share the same reference numerals for same and corresponding parts.

Hence, FIGS. 1-10 illustrate a saw blade arrangement 100 according to a first exemplifying embodiment of the present invention. The saw blade arrangement 100 is associated with a width W, a length Land a depth D, following the same notation throughout FIGS. 1-13.

The saw blade arrangement 100 is arranged to be used for a chainsaw, and as such the saw blade arrangement 100 comprises a chassis 103, a saw blade 110 and a chain 101. In FIGS. 1-12, the chassis 103 and the chain 101 are not shown, it being understood that such chasses and such chains are conventional as such and can vary in their details. In general, the saw blade 110 is detachably connected or detachably connectable, at a proximal end 113 of the saw blade 110, to the chassis 103 by a saw blade fastening mechanism arranged to fasten and hold a saw blade 110 in relation to the chassis 103, and the chain 101 is moved along a chain guide 116 of the saw blade by an electric, hydraulic or explosion-type motor 102 arranged in or in connection to the chassis 103. The chain guide 116 is typically peripheral to the saw blade 110, guiding the chain 101 along each of the width-wise W side edges of the saw blade 110, said side edges facing in opposite width W directions. See FIG. 13.

A broken-line arrow is used to denote a direction of movement of the chain 101.

The saw blade 110 has a first side 101 and an opposite second side 102.

Furthermore, the saw blade arrangement 100 comprises a nose part 130, in turn having a chain sprocket 150 about which the chain 101 turns at a distal end 114 of the saw blade 110.

Furthermore, the saw blade arrangement 100 comprises a lubricant provision device 104, such as an oil pump with associated oil conduits, arranged to provide a lubricant, such as oil, to the chain 101 mounted on the saw blade 110.

It is noted that such saw blade arrangements 100 are well-known as such, and that the saw blade arrangements 100, 200 and 300 all share these conventional properties. In the following, unless explicitly stated otherwise, the description will for reasons of simplicity be in relation to the saw blade arrangement 100. It is, however, realized that all which is said in relation to the saw blade arrangement 100 is equally applicable, pending compatibility, also to saw blade arrangements 200 and 300. The chainsaw can be a forest harvester, but in some embodiments the chainsaw is a handheld chainsaw.

As is illustrated in the Figures, the saw blade 110 can comprise a lubricant supply channel, such as a respective a lubricant supply channel 121, 122 on either width-direction W side of the saw blade 110, each such lubricant supply channel 121, 122 running lengthwise L along the chain guide 116 from the chassis 103 to the nose part 130.

The saw blade 110 can furthermore comprise a lubricant distribution channel 151, arranged to provide lubricant from the lubricant supply channel 121, 122 to the chain 101 mounted on and moving about the periphery of the saw blade 110. Said lubricant distribution channel 151 can also be arranged to provide the lubricant to an upstream lubrication point 154 on the nose part 130. That the lubrication point 154 is “upstream” means, herein, that the lubrication point 154 is provided at a point on the saw blade 110 in relation to the chain 101 so that lubricant being provided by the lubricant distribution channel 151 to the lubrication point 154 is provided to the chain 101 before the point on the chain 101 to which the lubricant is provided arrives at the chain sprocket 150. It is realized that the chain 101 is typically an endless chain, and that it will reach the chain sprocket 150 repeatedly during use of the chainsaw, but that the lubricant is applied to said point on the chain 101 after the point in question has left the chassis 103 but before it has reached the sprocket 150.

The lubricant is typically an oil.

Since the lubrication point 154 is provided at the nose part 130, the lubrication of the chain 101 also takes place at the nose part 130, near the sprocket 150. This is in contrast to conventional lubrication devices, that are configured to deliver lubricant to the chain 101 at a point near the chassis 103, typically at a point where the chain 101 leaves the chassis 103. This conventional application normally leads to a large share of the applied lubricant leaving the chain 101 before coming to use lubricating the chain 101, as described initially herein.

In some embodiments, all lubrication is provided to the chain 101 at the nose part 130, or at least 50% of the lubrication is provided to the chain 101 at the nose part 130, via the lubricant supply channel(s) 121, 122 and lubricant distribution channel(s) 151.

In some embodiments, the lubrication point 154 is located at least 30 cm from the chassis 103, along the length L of the saw blade 110.

The saw blade 110 can comprise a blade part 115 in the form of a piece of solid metal material, such as a solid piece of steel material. As conventional blade parts 115 are relatively thin, such as at the most 10 mm, such as between 3 mm and 10 mm, and may have a curvilinear peripheral shape, it may be difficult to provide the lubricant supply channel 121, 122 in the form of a drilled hole through the solid material of such a blade part 115, in particular in case such a drilled channel is to end at the nose part 130.

Instead, the present inventor has realized that it is possible to provide the lubricant supply channel 121, 122 at a bottom 117 of the chain guide 116. Namely, the chain guide 116 is normally designed with a channel for the chain 101 to run along, the channel being open outwards in the width direction W.

As is perhaps most clearly seen from FIGS. 8-10, an elongated element 119 can be provided in and along such open chain guide 116 channel so as to define a closed lubricant channel at the bottom 117 of the chain guide 116 channel. The elongated element 119 can be arranged, such as by pressing it down (in the width direction W) into the open channel, with the elongated element 119 having a slightly larger diameter than the channel so that a friction fit is achieved whereby the elongated element 119 seals against inside walls 118 of the open channel. At the same time, space can be left outside (width-wise W) of the elongated element 119 in and along said open channel for the chain 101 to run and be guided. This way, a closed channel for the lubricant is arranged along the widthwise W edge of the saw blade 110, while providing the chain guide 116 in accordance with a used standard for the chain 101.

The inside walls 118 can be slightly tapered width-wise W inwards, so as to achieve said press fit. In other embodiments, the elongated element 119 can be fastened using other means, such as welding or an adhesive/glue.

The elongated element can be a wire, such as a metal or plastic wire. In some embodiments, it is a steel wire.

As is, for instance, shown in FIG. 5, the lubricant supply channel 121, 122 can be aligned with and connect to the lubricant distribution channel 151 at a lengthwise L intersection between the saw blade 110 and the nose part 130, allowing the lubricant to pass between at least one lubricant supply channel 121, 122 and the lubricant distribution channel 151. It is realized that the lubricant supply channel 121, 122 can be made using said elongated element 119 whereas the lubricant distribution channel 151 can be made by milling or other machining, such as into the material of the blade part 115; hence the channels 121, 122, 151 can be aligned at their connection.

Generally, the nose part 130 can be a replaceable part and can be specifically arranged for use with the saw blade 110 in question. It can be fastened to the saw blade 110 using one or several fasteners 147, such as rivets or screws. Such fastening of the nose part 130 to the saw blade 110 will then automatically bring the nose part 130 into a predetermined geometric relationship relative to the saw blade 110, and the channels 121, 122, 151 can then be arranged so that their connection is sealed as a result of the fastening. The connection between channels 121, 122, 151 can be sealed using a gasket or similar, but in some embodiments no specific sealing means is necessary as long as the nose part 130 is shape-matched to the saw blade 110 at the connection in question.

The saw blade 110 can comprise one separate lubricant supply channel 121, 122 on either widthwise W side of the saw blade 110, each separate lubricant supply channel 121, 122 running along the chain guide 116 from the chassis 103 to the nose part 130 on either widthwise W side of the saw blade 110.

The lubricant distribution channel 151 can comprise two lubricant connecting channel parts 152, 153, each being aligned with and connected to a respective one of said separate lubricant supply channels 121, 122 at the mentioned lengthwise L intersection between the saw blade 110 and the nose part 130. This is perhaps most clearly seen in FIGS. 5 and 6, together with FIG. 10. In FIG. 10 it is also shown how the lubricant connecting channel parts 152, 153 can comprise a respective section in the form of a drilled hole to an edge of the saw blade 110, the hole opening out in the width direction W so as to connect to the lubricant supply channel 121, 122 in question.

Such drilled hole can be through a central plate 139 of the saw blade 110.

Namely, in some embodiments the nose part 130 comprises a first outer plate 131 and a second outer plate 135, whereas the saw blade 110 comprises a central plate 139. The central plate 139 is arranged depthwise D between the first outer plate 131 and the second outer plate 135 when the nose part 130 is mounted on the saw blade 110, so that the three plates 131, 139, 135 together form a sandwich-type aggregate.

In this and other embodiments, the saw blade 110 can comprise a first fastening flange 123 and a second fastening flange 125, the saw blade 110 being arranged to fasten to the nose part 130 by fastening the fastening flanges 123, 125 to the nose part 130.

To receive the first fastening flange 123, the first outer plate 131 of the nose part 130 can have a corresponding first socket 134, arranged to receive and accommodate the first fastening flange 123. To receive the second fastening flange 125, he second outer plate 135 of the nose part 130 can have a second socket 138, arranged to receive and accommodate he second fastening flange 125.

In some embodiments of the present invention, the first fastening flange 123 and the second fastening flange 125 can have shapes that do not align as viewed along the width W direction. Hence, as is the case in the exemplifying embodiments illustrated in the Figures, the fastening flange 123 is set to point slightly in one widthwise W direction, whereas the fastening flange 125 is set to point slightly in the opposite widthwise W direction. However, the non-alignment can be provided in numerous other ways, for instance by the fastening flanges 123, 125 having non-aligned step-wise straight edges defining a respective shape that leans in either width-wise W direction.

Said fasteners 147 can comprise a first fastener 148, fastening together the first fastening flange 123 and the second outer plate 135, via the central plate 139. In other words, the first fastener 148 fastens together the first fastening flange 123 to the second outer plate 135, the latter being arranged on an opposite side of the central plate 139 as compared to the first fastening flange 123, with the central plate 139 arranged between the two. The first fastening flange 123 can be arranged not to directly attach to the first outer plate 131.

The first fastener 148 can be provided via a corresponding through hole 124 in the first fastening flange 123, through which the first fastener 148 passes.

Moreover, the fasteners 147 can comprise a second fastener 149, fastening together the second fastening flange 125 and the first outer plate 131, via the central plate 139. In other words, the second fastener 149 fastens together the second fastening flange 125 to the first outer plate 131, the latter being arranged on an opposite side of the central plate 139 as compared to the second fastening flange 125, with the central plate 139 arranged between the two. The second fastening flange 125 can be arranged not to directly attach to the second outer plate 135.

The second fastener 149 can be provided via a corresponding through hole 126 in the second fastening flange 125, through which the second fastener 149 passes.

Apart from the first 148 and second 149 fasteners, the nose part 130 can be attached to the saw blade 110 using at least four, such as at least six, fasteners 147 distributed across the middle plate 139. These additional fasteners can each be arranged to pass through, and to fasten together, the first outer plate 131 via through holes 133, the central plate 139 via through holes 146, and the second outer plate 135 via through holes 137.

In some embodiments, the first fastening flange 123 and the second fastening flange 125 together cover at least 50% of a width W of the nose part 130, as measured near the connection between the nose part 130 and the saw blade 110. The fastening flanges 123, 125 can have a generally tapered respective shape, as is illustrated in the Figures (see, for instance, FIGS. 3 and 4). In this case, the fastening flanges 123, 125 can overlap substantially or even completely at a location nearest said connection, and from this point towards the distal end 114 the fastening flanges 125, 125 can taper in different directions in the plane being perpendicular to the depth direction D. The fastening flanges 123, 125 can be arranged so that they together cover at least 30%, or even at least 50%, of a width W of the nose part 130 measured at any (or all) selected length-wise L location between said connection and at least 5 cm towards the distal end 114.

It is realized that, in the embodiments shown in the Figures, the fastening flanges 123, 125 are arranged as parts of the saw blade 110, and can even be an integrated part of the saw blade 110, such as made from the same connected material body as the blade part 115 of the saw blade 110. However, it is also possible that the fastening flanges 123,125 are provided as parts of the nose part 130, whereas the sockets 134, 138 then are provided as parts of the saw blade 110, such as recesses in said connected material body.

The central plate 139 can also be a part of the same connected material body as the blade part 115 of the saw blade 110. In this case, the central part 139 and the fastening flanges 123, 125 hence constitute features of one and the same massive piece of metal forming said blade part 115. These features can be formed, for instance, by machining processing.

Non-aligned fastening flanges 123, 125 of the type described herein constitute a simple way of achieving a stronger, more durable saw blade 110 and nose part 130 aggregate. Namely, the non-aligning fastening flanges 123, 125 form a local weakness in the material of the saw blade arrangement which is less severe than a conventional fastening arrangement for a nose part onto a saw blade. Such weakness, which is always present in case of saw blade arrangements having separate nose parts, is crucial when the saw blade arrangement 100, 200, 300 is subjected to bending forces during sawing. The present inventor has realized that the difference is significant.

The outer plates 131, 135 can be parallel and define a space between them arranged to receive and accommodate the central plate 139, and possibly also the sprocket 150. The space between the outer plates 131, 135 can also define a channel for the chain 101 to run in and along between the chain guide 116 running along the saw blade 110 and the sprocket 150.

In some embodiments, the lubricant distribution channel 151 can be formed as a recess in the surface of the central plate 139. The recess can be on one side of the central plate 139 or, as is the case in the exemplifying embodiment illustrated in FIGS. 1-10, the recess can be arranged on both sides, the respective recess on either side each forming a part of the lubricant distribution channel 151. Either way, the lubricant distribution channel 151 can be defined by said recess and the first 131 and/or second 135 outer plate abutting the central plate 139, so that the flow of the lubricant through the lubricant distribution channel 151 is limited both by the central plate 139 material and the abutting side of the outer plate 131, 135 in question.

Such a recess can be made by milling or similar machining of the material of the central plate 139. As an alternative, the lubricant distribution channel 151 can be formed entirely or partly by drilling through the material of the central plate 139, in the width W and/or length L directions.

As is perhaps best shown in FIGS. 5-7, the lubricant distribution channel 151 can have a curvilinear shape, running past and around the fasteners 147 from the or each lubricant supply channel 121, 122 to the upstream lubrication point 154 and/or to a downstream lubrication point 155, avoiding passing too near through holes through which the fasteners 147 run.

The lubricant distribution channel 151 can comprise a first channel part 142, arranged to distribute the lubricant to said upstream lubrication point 154, and also a second channel part 144, instead arranged to distribute the lubricant to a downstream lubrication point 155. The downstream lubrication point 155 is then provided on the nose part 130 to provide the lubricant to the chain 101 at a point after the chain 101 leaves the chain sprocket 150.

It may even be so, as is illustrated in FIGS. 5-7, that the lubricant distribution channel 151 comprises at least two first channel parts 142 of said type and/or at least two second channel parts 144 of said type. For each such first channel part 142, there is then a corresponding upstream lubrication point 154 providing the lubricant to the chain 101 at a point upstream of the sprocket 150. For each such second channel part 144, there is a corresponding downstream lubrication point 155 providing the lubricant to the chain 101 at a point downstream of the sprocket 150. The lubricant distribution channel 151 can comprise the same or different number of first channel parts 142 and second channel parts 144. The present inventors have experienced sufficient lubrication using exactly two first channel parts 142 and exactly two second channel parts 144.

The upstream lubrication point 154 can be constituted by orifices 143 of the first channel part 142, and/or the downstream lubrication point 155 can be constituted by orifices 145 of the second channel part 144.

The different upstream lubrication points 154 can be separated by at least 1 cm in the length direction L, and/or the different downstream lubrication points 155 can be separated by at least 1 cm in the length direction L.

The lubricant distribution channel 151 can form a connected system of channels. Hence, the first channel parts 142 can be connected to the second channel parts 144 so that lubricant provided via either or both of the lubricant supply channels 121, 122 is distributed, via the lubricant distribution channel 151, to at least one of, such as all, upstream lubrication points 154 and also to at least one of, such as all, downstream lubrication points 155.

To achieve this, each first channel part 142 can be formed as a recess in the central plate 139 on a first side of the central plate 139 whereas each second channel part 144 can be formed as a recess in the central plate 139 on a second, opposite side of the central plate 139. Then, the first channel part 142 can be connected to the second channel part 144 via a through hole 156 in the central plate 139.

It is also realized that the first lubricant connecting channel part 152 and the second lubricant connecting channel part 153 are connected to the first 142 and second 144 channel parts 144.

The lubricant provision device 104 can be connected to, and arranged to supply lubricant to both lubricant supply channels 121, 122, or only to one 122 of the lubricant supply channels that is arranged upstream of the sprocket 150.

In some embodiments, the downstream lubricant channel 121 is blocked at the chassis 103 as a result of the saw blade 110 being attached to the chassis 103. Then, the lubricant will be supplied, from the supply device 104, via the upstream lubricant supply channel 122 and the lubricant distribution channel 151, to both the lubrication points 154, 155 but also to the downstream lubricant supply channel 121. However, due to said blocking no or only very little lubricant will pass through the downstream lubricant supply channel 121 as a result of the lubricant pressure provided by the supply device 104.

In some embodiments, the lubricant provision device 104 can be arranged to provide lubricant to both lubricant supply channels 121, 122 at a respective connection point between the lubricant supply channel 121, 122 in question and the chassis 103 at the proximal end 113 of the saw blade 110. In some embodiments, the lubricant provision device 104 can be arranged to selectively deliver lubricant to one specific, or both, of the lubricant supply channels 121, 122. In these and other cases, the respective distal end of one or both of the lubricant supply channels 121, 122 can be arranged so that lubricant supplied to the lubricant supply channel 121, 122 leaks out from the lubricant supply channel 121, 122 at its distal end and comes into direct contact with the chain 101 at that point. Hence, in this case the lubricant never enters the lubricant distribution channel 151.

This way, the saw blade 110 with the lubricant supply channels 121, 122 can be used also without a lubricant distribution channel 151.

FIG. 14 shows a method for manufacturing a saw blade arrangement 100, 200, 300 of the type described herein.

In a first step, the method starts.

In a subsequent step, the saw blade 110 is provided, having the chain guide 116 running from the chassis 103 to the nose part 130 when the saw blade 110 is mounted on the chassis 103.

In a subsequent step, part of the chain guide 116 is sealed off so as to define the lubricant supply channel 121 and/or 122, running along said chain guide 116.

As described above, the lubricant supply channel 121, 122 in question can be defined by a elongated element 119 being provided in an open channel of the chain guide 116, the elongated element 119 then sealing against the inside walls 118 of the open channel and leaving space (width-wise W) outside of the elongated element 119 for the chain 101 in and along the open channel.

Specifically, the elongated element 119 can be between 1 and 4 mm in a cross-sectional diameter, and it can be fastened using press fitting into and in the open channel, by pressing the elongated element 119 into the open channel to a desired depth. The resulting lubricant supply channel can be between 1 and 4 mm wide (in the width direction W).

At the distal end of the open channel, near the nose part 130, the elongated element 119 can be fastened to the saw blade 110 using a local weld 120 or adhesive/glue so as to seal the end of the lubricant supply channel 121, 122 in question, forcing the lubricant width-wise W inwards at the end of the lubricant supply channel 121, 122, into the lubricant distribution channel 151.

In another step, that can be performed before or after the saw blade 110 provision step, the lubricant distribution channel 151 is provided, in turn being arranged to provide lubricant from the lubricant supply channel 121 and/or 122 to the chain 101, and specifically to the upstream 154 and possibly also the downstream 155 lubrication point, when the chain 101 is mounted on the saw blade 110 and the nose part 130 is attached to the saw blade 110.

The lubricant distribution channel 151 can be formed, such as by milling and/or drilling, for instance as has been described above, as a recess in a central plate 139 of the saw blade 110.

Also, the method can comprise mounting the nose part 130 to the saw blade 110 by fastening the first outer plate 131 and the second outer plate 135 on either side of the central plate 139, such as using fasteners 147 as described above, and in particular using the first fastener 148 and the second fastener 149.

The fasteners 147 can all be rivets or screws.

For retrofit versions of the method, the saw blade 110 can be an existing saw blade, such as a conventional saw blade that is adapted by providing one or both of the lubricant supply channels 121, 122 along the chain guide 116, and possibly also by providing the lubricant distribution channel 151 as described above, in a central plate 139 of the saw blade 110.

It is noted that the same nose part 130 can be used with several different saw blades 110, such different saw blades 110 having different lengths L but sharing the same connection geometry for the nose part 130.

In a subsequent step, the method ends.

FIG. 15 shows a method for using a saw blade arrangement 100, 200, 300 of the present type.

In a first step, the method starts.

In a subsequent step, the saw blade arrangement 100, 200, 300 is provided.

In a subsequent step, the saw blade arrangement 100, 200, 300 is fastened to a chainsaw so that a first long side edge of the saw blade 110 is used as a cutting edge of the saw blade 110. This first long side edge can be the one along which the second lubricant supply channel 122 runs, in the corresponding chain guide channel.

In a subsequent step, material (such as wood) is cut using the cutting edge while providing lubricant to the chain 101 via the lubricant distribution channel 151 as described above. The lubricant can be supplied by an oil pump at a certain pressure (typically about 4-5 bars) that is enough to force the lubricant to run up to and exit via at least one of the lubrication points 154, 155.

Hence, lubricant will be provided via the second lubricant supply channel 122 and the lubricant distribution channel 151 at least to the upstream lubrication point 154, lubricating the chain 101 at a point upstream of the sprocket 150. It is noted that most of the lubricant will stay on the chain 101 as it revolves around the sprocket 150, back into the chassis 103 and again to the chain guide part along the second lubricant supply channel 122, offering lubrication of the chain 101 to the location where the chain 101 is pressed onto the saw blade 110 by the sawn material.

In the example shown in FIGS. 1-10, lubricant will be provided via the two upstream lubrication points 154 as well as via the two downstream lubrication points 155.

In a subsequent step, the saw blade 110 is detached from the chassis 103 and re-attached thereto in a turned state, in which a second, opposite, long side edge of the saw blade 110 is instead used as the cutting edge of the saw blade 110. Hence, the turning of the saw blade 110 is 180° about a longitudinal (lengthwise) L axis. Said second long side edge can be the one along which the first lubricant supply channel 121 runs, in the corresponding chain guide channel.

In connection to the turning of the saw blade 110, the chain 101 can also be replaced as needed.

It is noted that the nose part 130 can be turned together with the saw blade 110, without being detached from the saw blade 110 in the process.

In a subsequent step, material is then cut using the new cutting edge while providing lubricant to the chain 101 via the lubricant distribution channel 151. Hence, lubricant will then be provided via the first lubricant supply channel 121 and the lubricant distribution channel 151 at least to the downstream lubrication point 154 that has now turned into an upstream lubrication point due to the turning of the saw blade 110. This way, the chain 101 is again lubricated at a point upstream of the sprocket 150, that now turns in the opposite direction as compared to before the turning of the saw blade 110. Again, most of the lubricant will stay on the chain 101 as it revolves around the sprocket 150, back into the chassis 103 and again to the chain guide part along the first lubricant supply channel 121, offering lubrication of the chain 101 to the location where the chain 101 is pressed onto the saw blade 110 by the sawn material.

Again in the example shown in FIGS. 1-10, lubricant will be provided via the two upstream lubrication points 154 (that have now turned into downstream lubrication points) as well as via the two downstream lubrication points 155 (that have now turned into upstream lubrication points).

The method can also comprise the step of plugging the lubrication point(s) that are currently arranged downstream of the sprocket 150, for instance using screw plugs, forcing the lubricant to only be delivered to the chain 101 upstream of the sprocket 150.

In a subsequent step, the method ends.

Above, preferred embodiments have been described. However, it is apparent to the skilled person that many modifications can be made to the disclosed embodiments without departing from the basic idea of the invention.

For instance, the connection between the nose part 130 and the saw blade 110 can be as described above or in other ways. The presently described principles regarding lubrication can also be applied in saw blade arrangements that do not involve detachable nose parts.

The design of the chassis and chainsaw can vary.

All that has been described herein in relation to the saw blade arrangements 100, 200, 300 is equally applicable to the described methods, and vice versa.

Hence, the invention is not limited to the described embodiments, but can be varied within the scope of the enclosed claims.

1. A saw blade arrangement for a chainsaw, the saw blade arrangement being associated with a width, a length and a depth, the saw blade arrangement comprising
a chassis comprising a saw blade fastening mechanism arranged to fasten and hold a saw blade
the saw blade, having a chain guide for a chain along each of its side edges facing in opposite width directions, the saw blade comprising a blade part in the form of a piece of solid metal material;
a replaceable nose part having a chain sprocket; and
a lubricant provision device, arranged to provide a lubricant to a chain mounted on the saw blade,
wherein:
the saw blade comprises a lubricant supply channel, provided at a bottom of the chain guide and running lengthwise along said chain guide from the chassis to the nose part, wherein
the lubricant supply channel is defined by an elongated element being arranged in an open guide channel of the chain guide the elongated element sealing against inside walls of the open channel and leaving space outside of the elongated element for the chain in and along the open channel, wherein
the saw blade further comprises a lubricant distribution channel arranged to provide lubricant from the lubricant supply channel to a chain mounted on the saw blade, wherein
the lubricant supply channel is aligned with and connects to the lubricant distribution channel at a lengthwise intersection between the saw blade and the nose part, and wherein
the lubricant distribution channel is arranged to provide the lubricant to an upstream lubrication point on the nose part, the upstream lubrication point being arranged at a point on the saw blade in relation to the chain so that lubricant provided by the lubricant distribution channel to the upstream lubrication point is provided to the chain before the point on the chain to which the lubricant is provided arrives at the chain sprocket.

2. The saw blade arrangement according to claim 1, wherein
the chainsaw is a forest harvester.

3. The saw blade arrangement according to claim 1, wherein
the saw blade comprises one separate lubricant supply channel on either widthwise side of the saw blade, each separate lubricant supply channel running along said chain guide from the chassis to the nose part, and wherein
the lubricant distribution channel comprises two lubricant connecting channel parts, each being aligned with and being connected to a respective one of said separate lubricant supply channels at a lengthwise intersection between the saw blade and the nose part.

4. The saw blade arrangement according to claim 1, wherein
the nose part comprises a first outer plate and a second outer plate, and wherein
the saw blade comprises a central plate, the central plate being arranged depthwise between the first outer plate and the second outer plate when the nose part is mounted on the saw blade.

5. The saw blade arrangement according to claim 4, wherein
the saw blade comprises a first fastening flange and a second fastening flange, wherein
the first outer plate has a first socket for the first fastening flange and the second outer plate has a second socket for the second fastening flange, and wherein
the first fastening flange and the second fastening flange have shapes that do not align as viewed along the width direction.

6. The saw blade arrangement according to claim 5, wherein
the nose part is fastened to the saw blade using several fasteners.

7. The saw blade arrangement according to claim 6, wherein the fasteners comprise
a first fastener fastening together the first fastening flange, the central plate and the second outer plate; and
a second fastener fastening together the second fastening flange, the central plate and the first outer plate.

8. The saw blade arrangement according to claim 6, wherein
the lubricant distribution channel has a curvilinear shape, running past said fasteners from the lubricant supply channel to said first upstream lubrication point.

9. The saw blade arrangement according to claim 5, wherein
the first fastening flange and the second fastening flange together cover at least 50% of a width of the nose part near a connection between the nose part and the saw blade.

10. The saw blade arrangement according to claim 4, wherein
the lubricant distribution channel is formed as a recess in the central plate.

11. The saw blade arrangement according to claim 1, wherein
the lubricant distribution channel comprises a first channel part arranged to distribute the lubricant to said upstream lubrication point and also a second channel part arranged to distribute the lubricant to a downstream lubrication point on the nose part after the chain leaves the chain sprocket.

12. The saw blade arrangement according to claim 11, wherein
the lubricant distribution channel comprises at least two first channel parts and at least two second channel parts.

13. The saw blade arrangement according to claim 5, wherein
the lubricant distribution channel comprises a first channel part arranged to distribute the lubricant to said upstream lubrication point and also a second channel part arranged to distribute the lubricant to a downstream lubrication point on the nose part after the chain leaves the chain sprocket, wherein
the first channel part is formed as a recess in the central plate on a first side of the central plate, wherein
the second channel part is formed as a recess in the central plate on a second, opposite side of the central plate, and wherein
the first channel part is connected to the second channel part via a through hole in the central plate.

14. A method for manufacturing a saw blade arrangement according to claim 1, comprising the steps
a) providing a saw blade having a chain guide from a chassis of the saw blade arrangement to a nose part of the saw blade;
b) sealing off part of the chain guide so as to define a lubricant supply channel running along said chain guide
c) providing a lubricant distribution channel arranged to provide lubricant from the lubricant supply channel to a chain mounted on the saw blade, the lubricant distribution channel being arranged to provide the lubricant to an upstream lubrication point on the nose part before the chain arrives at the chain sprocket.

15. The method according to claim 14, wherein
the lubricant supply channel is defined by an elongated element being arranged in an open channel of the chain guide, the elongated element sealing against inside walls of the open channel and leaving space outside of the elongated element for the chain in and along the open channel.

16. The method according to claim 15, wherein
the elongated element is between 1 and 4 mm in a cross-sectional diameter.

17. The method according to claim 15, wherein
the elongated element is fastened using press fitting in the open channel, by pressing the elongated element into the open channel to a desired depth.

18. The method according to claim 15, wherein
the elongated element is fastened to the saw blade using welding or an adhesive at an end of the open channel near the nose part.

19. The method according to claim 14, further comprising the steps
forming the lubricant distribution channel as a recess in a central plate of the saw blade; and
mounting the nose part to the saw blade by fastening a first outer plate and a second outer plate on either side of the central plate.

20. A method for using a saw blade arrangement according to claim 1, comprising the steps
a) providing the saw blade arrangement;
b) fastening the saw blade arrangement to a chainsaw so that a first long side edge of the saw blade is used as a cutting edge of the saw blade;
c) cutting material using the cutting edge while providing lubricant to the chain via the lubricant distribution channel;
d) turning the saw blade so that a second long side edge of the saw blade is used as a cutting edge of the saw blade; and
e) cutting material using the cutting edge while providing lubricant to the chain via the lubricant distribution channel.
